(19) United States
(12) Patent Application Publication
(10) Pub. No.: US 2011/0143581 A1
(43) Pub. Date: Jun. 16, 2011

(54) INTELLIGENT ELECTRICAL CONNECTOR SYSTEM

(75) Inventors: Robert J. Brenneman, Stormville, NY (US); Eli M. Dow, Poughkeepsie, NY (US); Marie R. Laser, Poughkeepsie, NY (US); Jessie Yu, Wappingers Falls, NY (US)

(73) Assignee: International Business Machines Corporation, Armonk, NY (US)

(21) Appl. No.: 12/637,093

(22) Filed: Dec. 14, 2009

(51) Int. Cl. H01R 3/00

(52) U.S. Cl. 439/488

(57) ABSTRACT

An intelligent electrical connector system may include an electrical connector, and a transceiver carried by the electrical connector. The system may also include a second electrical connector, and a second transceiver carried by the second electrical connector. The second transceiver may relay interface information to the transceiver regarding the second electrical connector's parameters.

### BACKGROUND OF THE INVENTION

1. Field of the Invention

The invention relates to the field of electrical systems, and, more particularly, to electrical connectors within such.

2. Description of Background

There are many types of electrical connectors. The configuration of an electrical connector may incorporate the requirements of the component for which it powers and/or provides a communication link for. The configuration of the electrical connector may also incorporate the requirements of the electrical connector itself and/or the system to which it is designed to mate to.

Temporary and/or semi-permanent electrical connectors are very common. For example, surge protectors, surge protectors with multiple plug ports, battery backup units, backup units with multiple plug ports, power strips, and/or the like generally come with at least some temporary electrical connectors in the form of a male electrical connector, e.g. male plug, which is designed to mate with a female electrical component, e.g. female electrical receptacle, and perhaps a series of female electrical components. The flexibility of the design of such enables numerous configurations of connections, e.g. daisy chaining of surge protectors or outlet multipliers.

### SUMMARY OF THE INVENTION

According to one embodiment of the invention, an intelligent electrical connector system may include an electrical connector, and a transceiver carried by the electrical connector. The system may also include a second electrical connector, and a second transceiver carried by the second electrical connector. The second transceiver may relay interface information to the transceiver regarding the second electrical connector's parameters.

The interface information may include orientation requirements for the electrical connector, shape requirements for the electrical connector, electrical requirements of the electrical connector, and/or size requirements for the electrical connector. The electrical connector mechanically and/or electrically configures itself based upon the orientation requirements for the electrical connector, the shape requirements for the electrical connector, the electrical requirements of the electrical connector, and/or the size requirements for the electrical connector.

The transceiver may comprise a radio-frequency identification tag. The second transceiver may comprise a radio-frequency identification tag.

The interface information may be relayed prior to any physical interaction between the electrical connector and the second electrical connector and/or after physical interaction between the electrical connector and the second electrical connector. The interface information may be relayed when second transceiver becomes aware of the transceiver and/or the transceiver provides the electrical connector's parameters.

The electrical connector may comprise a male electrical connector. The second electrical connector may comprise a female electrical connector.

The interface information may include the orientation requirements for the second electrical connector, the shape requirements for the second electrical connector, the electrical requirements of the second electrical connector, and the size requirements for the second electrical connector. The second electrical connector mechanically and/or electrically configures itself based upon the orientation requirements for the second electrical connector, the shape requirements for the second electrical connector, the electrical requirements of the second electrical connector, and the size requirements for the second electrical connector.

The interface information may be passed on to at least one other electrical connector by the second transmitter. The communications between the transmitter and the second transmitter may be substantially restricted to the transmitter and the second transmitter.

In another embodiment, the system may include a male electrical connector, and a radio-frequency identification tag carried by the male electrical connector. The system may also include a female electrical connector, and a second radio-frequency identification tag carried by the female electrical connector, the second radio-frequency identification tag to relay interface information to the radio-frequency identification tag regarding the female electrical connector's parameters.

The interface information may include the orientation requirements for the male electrical connector, the shape requirements for the male electrical connector, the electrical requirements of the male electrical connector, and the size requirements for the male electrical connector. The male electrical connector mechanically and/or electrically configures itself based upon the orientation requirements for the male electrical connector, the shape requirements for the male electrical connector, the electrical requirements of the male electrical connector, and/or the size requirements for the male electrical connector.

The interface information may be relayed, at least one of, prior to any physical interaction between the male electrical connector and the female electrical connector and/or after physical interaction between the male electrical connector and the female electrical connector. The interface information may be relayed when the second radio-frequency identification tag becomes aware of the radio-frequency identification tag and/or the radio-frequency identification tag provides the male electrical connector's parameters.

The interface information may include the orientation requirements for the female electrical connector, the shape requirements for the female electrical connector, the electrical requirements of the female electrical connector, and/or the size requirements for the female electrical connector. The female electrical connector mechanically and/or electrically configures itself based upon the orientation requirements for the female electrical connector, the shape requirements for the female electrical connector, the electrical requirements of the female electrical connector, and/or the size requirements for the female electrical connector.

The interface information may be passed on to at least one other electrical connector by the second radio-frequency identification tag. The communications between the radio-frequency identification tag and the second radio-frequency identification tag may be substantially restricted to the radio-frequency identification tag and the second radio-frequency identification tag.

In another embodiment, the system may include a male electrical connector, and a radio-frequency identification tag carried by the male electrical connector. The system may also include a female electrical connector, and a second radio-frequency identification tag carried by the female electrical connector. The second radio-frequency identification tag may relay interface information to the radio-frequency identification tag regarding the female electrical connector's parameters. The communications between the radio-frequency identification tag and the second radio-frequency identification tag may be substantially restricted to the radio-frequency identification tag and the second radio-frequency identification tag. The interface information may be passed on to at least one other electrical connector by the second radio-frequency identification tag.

Another aspect of the invention is a method for an intelligent electrical connector. The method may include configuring an electrical connector to carry a transceiver. The method may also include configuring a second electrical connector to carry a second transceiver, the second transceiver to relay interface information to the transceiver regarding the second electrical connector's parameters.

The method may additionally include providing, at least one of, orientation requirements for the electrical connector, shape requirements for the electrical connector, electrical requirements of the electrical connector, and size requirements for the electrical connector for the interface information. The method may also include configuring the electrical connector to, at least one of, mechanically and electrically configures itself based upon, at least one of, orientation requirements for the electrical connector, shape requirements for the electrical connector, electrical requirements of the electrical connector, and size requirements for the electrical connector.

The method may further include relaying the interface information, at least one of, prior to any physical interaction between the electrical connector and the second electrical connector, and after physical interaction between the electrical connector and the second electrical connector. The method may additionally include relaying the interface information when, at least one of, the second transceiver becomes aware of the transceiver, and the transceiver provides the electrical connector's parameters.

### BRIEF DESCRIPTION OF THE DRAWINGS

FIG. 1 is a schematic block diagram of an intelligent electrical connector system in accordance with the invention.

### DETAILED DESCRIPTION OF THE INVENTION

The invention will now be described more fully hereinafter with reference to the accompanying drawings, in which preferred embodiments of the invention are shown. Like numbers refer to like elements throughout, like numbers with letter suffixes are used to identify similar parts in a single embodiment, and prime notations are used to indicate similar elements in alternative embodiments.

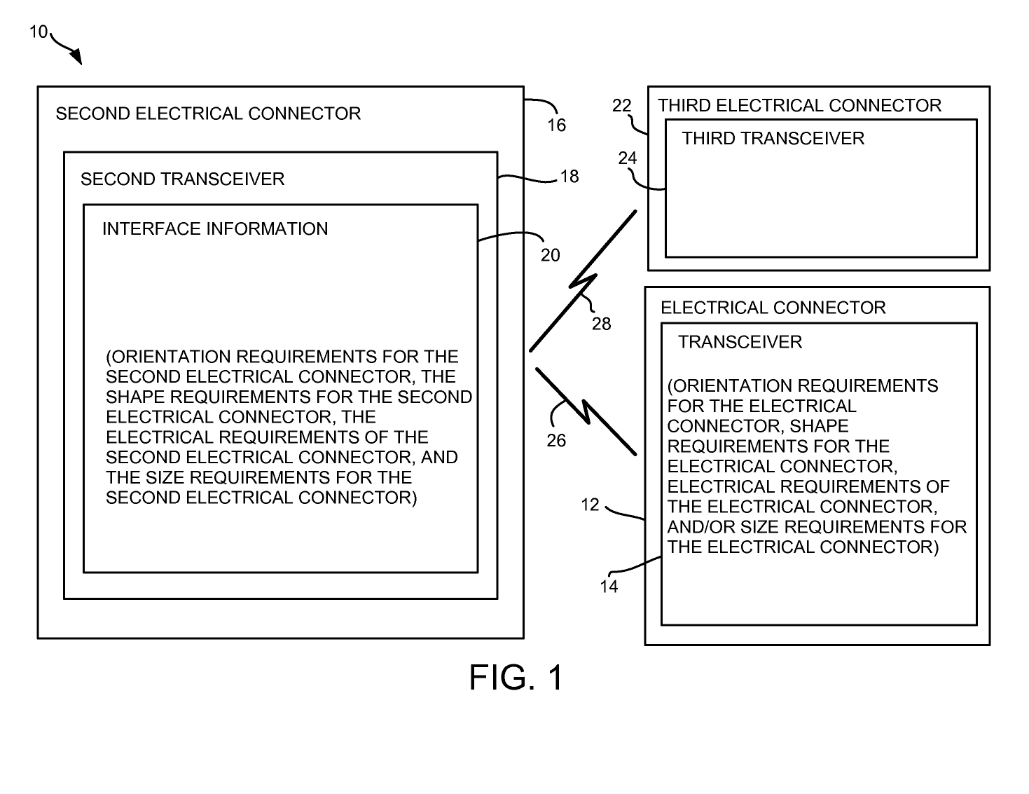

With reference now to FIG. 1, a system 10 of an intelligent electrical connector is initially described. In one embodiment, the system 10 may include an electrical connector 12. For example, the electrical connector 12 is male, female, and/or the like. The system also includes a transceiver 14 carried by the electrical connector 12. For instance, the transceiver 14 comprises a radio-frequency identification tag or the like. The system 10 further includes a second electrical connector 16. For example, the second electrical connector 12 is male, female, and/or the like. The system also includes a second transceiver 18 carried by the second electrical connector 16. For instance, the second transceiver 14 comprises a radio-frequency identification tag or the like and is configured to communicate with the transceiver 14. The system 10 further includes the second transceiver 18 relaying interface information 20 to the transceiver 14 regarding the second electrical connector's 16 parameters.

In one embodiment, the interface information 20 is relayed prior to any physical interaction between the electrical connector 12 and the second electrical connector 16. In other words, the transceiver 14 communicates with the second transceiver 18 over a communication link 26 that is wireless as will be appreciated by those of skill in the art. In another embodiment, the interface information 20 is relayed after physical interaction between the electrical connector 12 and the second electrical connector 16. Stated another way, the transmitter 14 communicates with the second transceiver 18 through a physical connection over communication link 26. In another embodiment, the transceiver 14 communicates with the second transceiver 18 wirelessly although a physical connection between the two has been made. In other words, the transceiver 14 is embedded in electrical connector 14, but communicates wirelessly with the second electrical connector 16 through the electrical connector.

In one embodiment, the interface information 20 is relayed when second transceiver 18 becomes aware of the transceiver 14. In other words, the second transceiver 18 is passive and is activated by the present of the transceiver 14 and/or the second transceiver is active and waits for acknowledgement by the transceiver 14 such as by the transceiver providing the electrical connector's 12 parameters.

In one embodiment, the interface information 20 includes orientation requirements for the electrical connector 12, e.g. where on the second electrical connector 16 the electrical connector 14 is to permitted to mate. In another embodiment, the interface information 20 includes shape requirements for the electrical connector 12, e.g. physical layout of the mating surfaces for a mating with the second electrical connector 16. In another embodiment, the interface information 20 includes electrical requirements of the electrical connector 14, e.g. electrical load, type of electrical load, and/or the like. In another embodiment, the interface information 20 includes size requirements for the electrical connector 14.

In another embodiment, the electrical connector 12 mechanically and/or electrically configures itself based upon the orientation requirements for the electrical connector, the shape requirements for the electrical connector, the electrical requirements of the electrical connector, and/or the size requirements for the electrical connector. In other words, the electrical connector 12 has many potential configurations, and any configuration that matches the parameters selected by system 10 can be deployed.

In one embodiment, the interface information 20 includes the orientation requirements for the second electrical connector 16, the shape requirements for the second electrical connector, the electrical requirements of the second electrical connector, and the size requirements for the second electrical connector. In another embodiment, the second electrical connector 16 mechanically and/or electrically configures itself based upon the orientation requirements for the second electrical connector, the shape requirements for the second electrical connector, the electrical requirements of the second electrical connector, and the size requirements for the second electrical connector.

In one embodiment, the interface information 20 is passed on to at least one other electrical connector 22 by the second transmitter 18. In another embodiment, the at least one other electrical connector 22 carries a third transceiver 24 that communicates with the second transceiver over communications link 28. Stated another way, there can be a plurality of electrical connectors and/or transceivers and the system 10 can organize and manage any of the electrical connectors in view of the demands and requirements of the rest of the electrical connectors

In another embodiment, the communications between the transmitter 14 and the second transmitter 18 is substantially restricted to the transmitter and the second transmitter. In other words, the communications is shielded from other electrical connectors and/or private between the transmitter 14 and the second transmitter 18. This can be achieved by signal shielding, identification friend or foe techniques, and/or the like.

In one embodiment, the system 10 includes a male electrical connector 12, and a radio-frequency identification tag 14 carried by the male electrical connector. The system 10 also includes a female electrical connector 16, and a second radio-frequency identification tag 18 carried by the female electrical connector, the second radio-frequency identification tag to relay interface information 20 to the radio-frequency identification tag 14 regarding the female electrical connector's parameters.

In one embodiment, the interface information 20 includes the orientation requirements for the male electrical connector 12, the shape requirements for the male electrical connector, the electrical requirements of the male electrical connector, and the size requirements for the male electrical connector. In another embodiment, the male electrical connector 12 mechanically and/or electrically configures itself based upon the orientation requirements for the male electrical connector, the shape requirements for the male electrical connector, the electrical requirements of the male electrical connector, and/or the size requirements for the male electrical connector.

In one embodiment, the interface information 20 is relayed, at least one of, prior to any physical interaction between the male electrical connector 12 and the female electrical connector 16 and/or after physical interaction between the male electrical connector and the female electrical connector. In another embodiment, the interface information 20 is relayed when the second radio-frequency identification tag 18 becomes aware of the radio-frequency identification tag 14 and/or the radio-frequency identification tag provides the male electrical connector's 12 parameters.

In one embodiment, the interface information 20 include the orientation requirements for the female electrical connector 16, the shape requirements for the female electrical connector, the electrical requirements of the female electrical connector, and/or the size requirements for the female electrical connector. In another embodiment, the female electrical connector 16 mechanically and/or electrically configures itself based upon the orientation requirements for the female electrical connector, the shape requirements for the female electrical connector, the electrical requirements of the female electrical connector, and/or the size requirements for the female electrical connector.

In one embodiment, the interface information 20 is passed on to at least one other electrical connector 22 by the second radio-frequency identification tag 20. In another embodiment, the communications between the radio-frequency identification tag 14 and the second radio-frequency identification tag 18 is substantially restricted to the radio-frequency identification tag and the second radio-frequency identification tag.

In one embodiment, the system 10 includes a male electrical connector 12, and a radio-frequency identification tag 14 carried by the male electrical connector. The system 10 also includes a female electrical connector 16, and a second radio-frequency identification tag 18 carried by the female electrical connector. The system 10 further includes a second radio-frequency identification tag 18 that relays interface information to the radio-frequency identification tag 14 regarding the female electrical connector's 16 parameters. The system 10 further includes the communications between the radio-frequency identification tag 14 and the second radio-frequency identification tag 18 is substantially restricted to the radio-frequency identification tag and the second radio-frequency identification tag. The system additionally includes the interface information 20 being passed on to at least one other electrical connector 22 by the second radio-frequency identification tag 18.

In view of the foregoing, the system 10 provides an intelligent electrical connection system. In one embodiment, system 10 uses a male plug 12 that can wirelessly receive a standard protocol and the plug can mechanically and electrically reconfigure itself into a corresponding orientation, shape, and size to properly receive power. In another embodiment, by embedding network transmission capabilities into an electrical connector 12 and/or 16, e.g. a surge mechanism, the system 10 can make intelligent power devices that can help limit improper use of the electrical connector.

For example, the system 10 provides an embedded radio-frequency identification tag (“RFID”) in each electrical connector 12 and/or 16 to broadcast whether or not it is plugged in to a main voltage or in too close a proximity to another electric connector. A more particular example is when an electrical connector, e.g. surge protector, is plugged in, it will look for peers, and if a peer is found too close (or the new surge strip is being plugged directly into an existing surge strip) the device will self disable.

In one embodiment, the system 10 dynamically conveys an electrical voltage and pin-out geometry of an electrical connector, e.g. a female electrical receptacle, a plurality of outlets as found on surge protection type device, a battery backup unit, an individual electrical male plug. Each outlet will carry an active RFID unit that transmits a pin-out and voltage map. The system 10 also includes a passive RFID tag equipped electrical male plug that it only communicates with only one particular female outlet in the system at a given time.

In another embodiment, the system 10 includes a passive RFID that is positioned in such a way as to only respond to a single corresponding active RFID transceiver. In another embodiment, the system 10 dynamically transmits power compatibility information including a radio frequency (RF) transceiver outputting the appropriate voltage pin-out map for one or more electrical connectors, e.g. electrical outlets. In another embodiment, the system 10 further includes one or more electrical connections equipped with the passive RFID tag(s) and associated circuitry/software to produce a pairing of suitable electrical connector before completing the main power circuit.

In one embodiment, the system 10 can test an outlet's voltage and pin-out by reading the information from a test of the outlet and/or by providing a dummy active signal to retrieve any passive RFID information from a plug. In another embodiment, the system 10 includes special types of devices that at times alter or embed an extra packet of information to be relayed through the system, which may limit daisy chaining of devices onto surge strips.

In one embodiment, the electrical connectors, e.g. outlets, are shielded from one another in a multi-outlet configuration, so one receptacle does not corrupt the information signal provided by a nearby receptacle. In another embodiment, the RFID tag is on one of the pins of the electrical connector so that it is physically encased when plugged in to an outlet.

In one embodiment, the RFID tag is powered by electrical supply running through the electrical connector, by a battery type carried by the tag, and/or by induction from the main voltage line. In another embodiment, the interface information 20 transmission could be XML and include pin-out information, standards information, and/or the like.

In one embodiment, a Euclidian plane is assigned to represent the surface of an electrical connector, e.g. an outlet, using a mechanism like the physics right hand rule where the male cable would be the thumb and the plane corresponds to looking at the thumb. In another embodiment, the system 10 electrical connectors, e.g. outlets, broadcast via RFID, or other means of wireless communication, an enumeration of tuples representing each pin. The tuples consist of regular protocol for location and physical size and shape and associated parameters for voltage, grounding, and/or the like.

In one embodiment, the location can be specified in degrees from top dead center and a radius from the centerpoint of the outlet. In another embodiment, shape is described via a numerical description of the polygon oriented in the same plane.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
an electrical connector;
a transceiver carried by the electrical connector;
a second electrical connector; and
a second transceiver carried by the second electrical connector, the second transceiver to relay interface information to the transceiver regarding the second electrical connector's parameters.

2. The system of claim 1 wherein the interface information includes, at least one of, orientation requirements for the electrical connector, shape requirements for the electrical connector, electrical requirements of the electrical connector, and size requirements for the electrical connector.

3. The system of claim 2 wherein the electrical connector, at least one of, mechanically and electrically configures itself based upon, at least one of, orientation requirements for the electrical connector, shape requirements for the electrical connector, electrical requirements of the electrical connector, and size requirements for the electrical connector.

4. The system of claim 1 wherein the transceiver comprises a radio-frequency identification tag; and wherein the second transceiver comprises a radio-frequency identification tag.

5. The system of claim 1 wherein the interface information is relayed, at least one of, prior to any physical interaction between the electrical connector and the second electrical connector, and after physical interaction between the electrical connector and the second electrical connector.

6. The system of claim 1 wherein the electrical connector comprises a male electrical connector; and wherein the second electrical connector comprises a female electrical connector.

7. The system of claim 1 wherein the interface information is relayed when, at least one of, the second transceiver becomes aware of the transceiver, and the transceiver provides the electrical connector's parameters.

8. The system of claim 1 wherein the interface information includes, at least one of, orientation requirements for the second electrical connector, shape requirements for the second electrical connector, electrical requirements of the second electrical connector, and size requirements for the second electrical connector.

9. The system of claim 8 wherein the second electrical connector, at least one of, mechanically and electrically configures itself based upon, at least one of, orientation requirements for the second electrical connector, shape requirements for the second electrical connector, electrical requirements of the second electrical connector, and size requirements for the second electrical connector.

10. The system of claim 1 wherein the interface information is passed on to at least one other electrical connector by the second transmitter.

11. The system of claim 1 wherein communications between the transmitter and the second transmitter is substantially restricted to the transmitter and the second transmitter.

12. A system comprising:
a male electrical connector;
a radio-frequency identification tag carried by the male electrical connector;
a female electrical connector; and
a second radio-frequency identification tag carried by the female electrical connector, the second radio-frequency identification tag to relay interface information to the radio-frequency identification tag regarding the female electrical connector's parameters.

13. The system of claim 12 wherein the interface information includes, at least one of, orientation requirements for the male electrical connector, shape requirements for the male electrical connector, electrical requirements of the male electrical connector, and size requirements for the male electrical connector.

14. The system of claim 13 wherein the male electrical connector, at least one of, mechanically and electrically configures itself based upon, at least one of, orientation requirements for the male electrical connector, shape requirements for the male electrical connector, electrical requirements of the male electrical connector, and size requirements for the male electrical connector.

15. The system of claim 12 wherein the interface information is relayed, at least one of, prior to any physical interaction between the male electrical connector and the female electrical connector, and after physical interaction between the male electrical connector and the female electrical connector.

16. A method for an intelligent electrical connector, the method comprising:
configuring an electrical connector to carry a transceiver; and
configuring a second electrical connector to carry a second transceiver, the second transceiver to relay interface information to the transceiver regarding the second electrical connector's parameters.

17. The method of claim 16 further comprising providing, at least one of, orientation requirements for the electrical connector, shape requirements for the electrical connector, electrical requirements of the electrical connector, and size requirements for the electrical connector for the interface information.

18. The method of claim 16 further comprising configuring the electrical connector to, at least one of, mechanically and electrically configures itself based upon, at least one of, orientation requirements for the electrical connector, shape requirements for the electrical connector, electrical requirements of the electrical connector, and size requirements for the electrical connector.

19. The method of claim 16 further comprising relaying the interface information, at least one of, prior to any physical interaction between the electrical connector and the second electrical connector, and after physical interaction between the electrical connector and the second electrical connector.

20. The method of claim 16 further comprising relaying the interface information when, at least one of, the second transceiver becomes aware of the transceiver, and the transceiver provides the electrical connector's parameters.
